(19) United States
(12) Patent Application Publication
(10) Pub. No.: US 2005/0207082 A1
(43) Pub. Date: Sep. 22, 2005

(54) Dual bus static tie switch

(76) Inventors: Martin S. Bosch, Shawnee, KS (US); David J. Darrah, Westlake, OH (US); Jaime J. Hummer, Shawnee, KS (US)

Correspondence Address: Hovey Williams LLP, Suite 400, 2405 Grand Blvd., Kansas City, MO, 64108, US

(21) Appl. No.: 10/802,202

(22) Filed: Mar. 17, 2004

(51) Int. Cl. H02H 7/06

(52) U.S. Cl. 361/107

(57) ABSTRACT

A static tie switch (10) designed to provide the upmost in reliable power to critical equipment, such as communications and computing equipment. The switch uses solid state devices, wherever possible, and preferable uses silicon controlled rectifiers (SCR)s (30) to tie corresponding phases of multiple buses (12,14) together. In the preferred embodiment, the switch (10) broadly comprises three pairs of SCRs (30), one pair for each phase, and a controller (32) to control the SCRs (30). The SCRs (30) can be triggered or biased to selectively allow current to flow between the buses (12,14), thereby allowing a first source (16) to power both a first load (18) and a second load (22). Similarly, the SCRs (30) can be triggered to selectively allow a second source (20) to power both the first load (18) and the second load (22).

### BACKGROUND OF THE INVENTION

1. Field of the Invention

The present invention relates to power systems. More particularly, the present invention relates to a static tie switch that is preferably connected between a first and second bus and operable to selectively tie the buses together.

2. Description of Prior Art

Many critical devices require redundant sources of power to ensure their continued operation during power interruptions. For example, communications and computing equipment are typically required during power interruptions, and are therefore usually considered critical. However, the prior art systems designed to provide the delivery of redundant power are typically overly complicated, dependant upon mechanical switchgear, or both, and therefore present reliability problems.

For example, one prior art system uses parallel single pole double throw switches to provide power to two loads from selected redundant power sources. These, and similar systems, are dependant upon such mechanical switches which present a single point of failure often requiring that power to critical loads be shut down. Specifically, when the switch fails, or otherwise requires maintenance, the entire system must be shut down. Of course, shutting down critical loads, such as communications and computing equipment, can be problematic.

Accordingly, there is a need for an improved static tie switch that overcomes the limitations of the prior art.

### SUMMARY OF THE INVENTION

The present invention overcomes the above-identified problems and provides a distinct advance in the art of redundant power systems. More particularly, the present invention provides a static tie switch that is preferably connected between a first and second bus and operable to selectively tie the buses together. Under normal operating conditions, the first bus connects a first power source to a first load and the second bus connects a second power source to a second load. Thus, the first source directly powers the first load the second source directly powers the second load. The buses may include circuit breakers operable to isolate any one or more of the sources and loads. It should be noted than the switch is primarily intended for three phase alternating current (AC) applications. However, the switch can be modified to accommodate other power systems, such as direct current (DC) or single phase AC.

The switch is designed to provide the upmost in reliability to provide power to critical equipment, such as communications and computing equipment. Therefore, the switch uses solid state devices, wherever possible, and preferably uses silicon controlled rectifiers (SCR)s to tie corresponding phases of the buses together. Thus, in the preferred embodiment, the switch broadly comprises three pairs of SCRs, one pair for each phase, and a controller to control the SCRs. The SCRs can be triggered or biased to selectively allow current to flow between the buses, thereby allowing the first source to power both the first load and the second load. Similarly, the SCRs can be triggered to selectively allow the second source to power both the first load and the second load.

The controller is preferably manually operated to trigger the SCRs. For example, if the first source is to be shut-down, the controller may simply substantially continuously trigger all of the SCRs, thereby effectively shorting the first bus to the second bus. The circuit breaker nearest the first source may also be actuated to isolate the first source. In this case, the second source provides power to both the second load and the first load through the buses and the switch. It should be noted that shorting the buses together in this manner would alternatively allow the second source to be shut-down and the first source would then provide power to the loads. It should be noted that the sources are preferably substantially synchronized in order to avoid inducing power quality and other issues.

The controller may have some control over the circuit breakers, such that the controller may open any one or more of the circuit breakers in order to isolate any one or more of the sources and/or loads. Thus, the controller can effectively instantly control power flow from the sources and to the loads. The controller may also include breaker indicators to indicate each circuit breaker's status.

The switch may also include a first and second bypass in order to provide for maintenance or replacement of any one or more of circuit breakers, the SCRs, the controller, or interconnecting wiring. The bypasses are preferably manually operated and completely independent from the controller. The bypasses may be tied together such that they operate substantially simultaneously. Alternatively, the bypasses may also be completely independent of each other. In either case, the first bypass is preferably operable to selectively connect the first input directly to the first output. Similarly, the second bypass is preferably operable to selectively connect the second input directly to the second output.

In use, when a user wishes to shut down either one of the sources, the user first verifies that the buses are synchronized. Then, the user manipulates the controller in order to tie the buses together. For example, the user may press the button or otherwise indicate that the controller is to tie the buses together. The controller triggers all of the SCRs, thereby effectively shorting corresponding phases of the buses.

At this point both sources are providing power to the buses and both loads are drawing power from the buses. It is expected that shorting the buses in this manner is not likely to cause significant disturbances in either of the sources or loads due to the characteristics of the SCRs.

Either the controller or the user may then open the circuit breaker closest to the source that the user wishes to shut down, thereby isolating that source. Alternatively, the controller may open the appropriate circuit breaker and trigger the SCRs substantially simultaneously. Where the controller is operable to open the circuit breakers, the user may indicate which source he or she wishes to isolate, using the button or another input.

Finally, the user may perform the desired operation on the isolated source without affecting either of the loads. When the user is finished and desires to bring the isolated source back online, the user simply closes the appropriate circuit breaker and separates the buses using the controller.

### BRIEF DESCRIPTION OF THE DRAWINGS

A preferred embodiment of the present invention is described in detail below with reference to the attached drawing figures, wherein:

FIG. 1 is a schematic diagram of a static tie switch constructed in accordance with a preferred embodiment of the present invention;

FIG. 2 is a schematic diagram of a portion of the switch;

FIG. 3 is a schematic diagram of the switch showing a controller having control over a plurality of circuit breakers;

FIG. 4 is a schematic diagram of the switch showing a plurality of bypasses; and

FIG. 5 is flow chart of the switch's preferred operation.

### DETAILED DESCRIPTION OF A PREFERRED EMBODIMENT

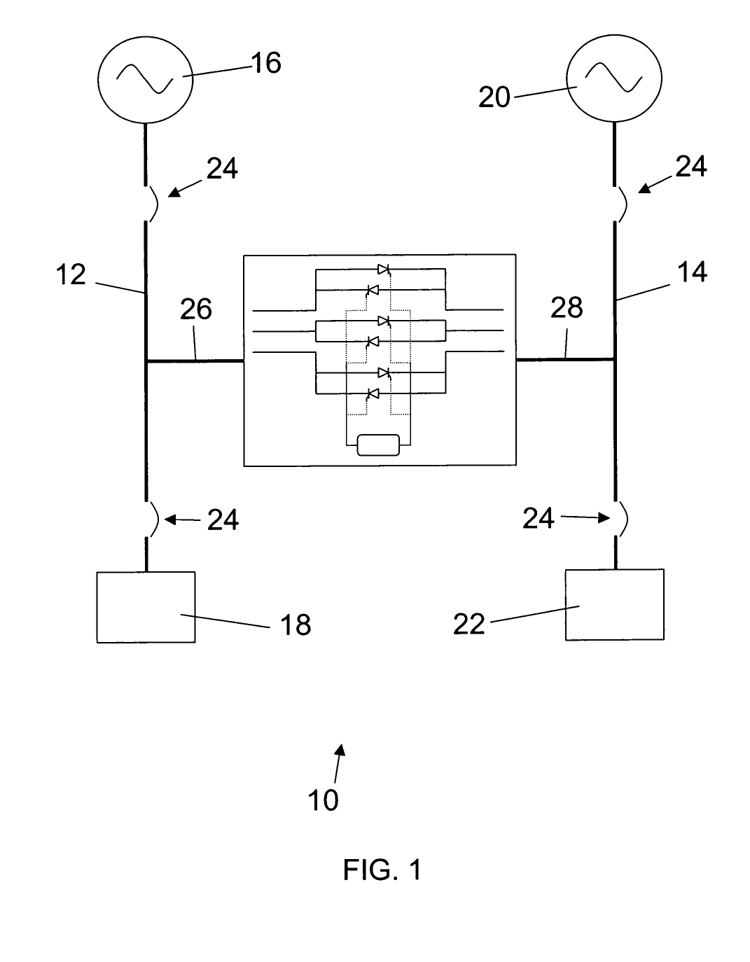

Referring to FIG. 1, the preferred static tie switch 10 constructed in accordance with a preferred first embodiment of the present invention is illustrated connected between a first and second bus 12,14. The first bus 12 connects a first power source 16 to a first load 18, thereby allowing the first source 16 to directly power the first load 18 under normal operating conditions. Similarly, the second bus 14 connects a second power source 20 to a second load 22, thereby allowing the second source 20 to directly power the second load 22 under normal operating conditions. The buses 12,14 may include circuit breakers 24 operable to isolate any one or more of the sources 16,20 and loads 18,22. During other than normal operations, such as an abnormal event or routine maintenance, one of the sources 16,20 may shut down or need to be shut down. In response to this situation, the switch 10 of the present invention allows both of the loads 18,22 to be powered by either one of the sources 16,20.

The buses 12,14 may be made of virtually any conventional power carrying conductors. However, the buses 12,14 are preferably made of conventional bus bars constructed from highly conductive metal, such as copper. The sources 16,20 are preferably completely redundant and independent. Furthermore, both sources 16,20 are preferably able to supply power to both loads indefinitely. The loads 18,22 may be virtually any electrically powered equipment. However, the as the switch 10 is designed for the utmost reliability, the loads 18,22 are preferably communications and computing equipment, such as might be found in a data center or call center.

The switch 10 is preferably connected to the first bus 12 through a first feeder 26. Similarly, the switch 10 is preferably connected to the second bus 14 through a second feeder 28. It should be noted than the switch 10 is primarily intended for three phase alternating current (AC) applications having a wye configuration. Thus, the feeders 24,26 and the circuit breakers 28 are preferably configured for three phase operation. Additionally, each circuit breaker 28 is preferably configured such that all three phases operate simultaneously. However, the switch 10 can be modified to accommodate other power systems, such as direct current (DC), single phase AC, or three phase applications having a delta configuration.

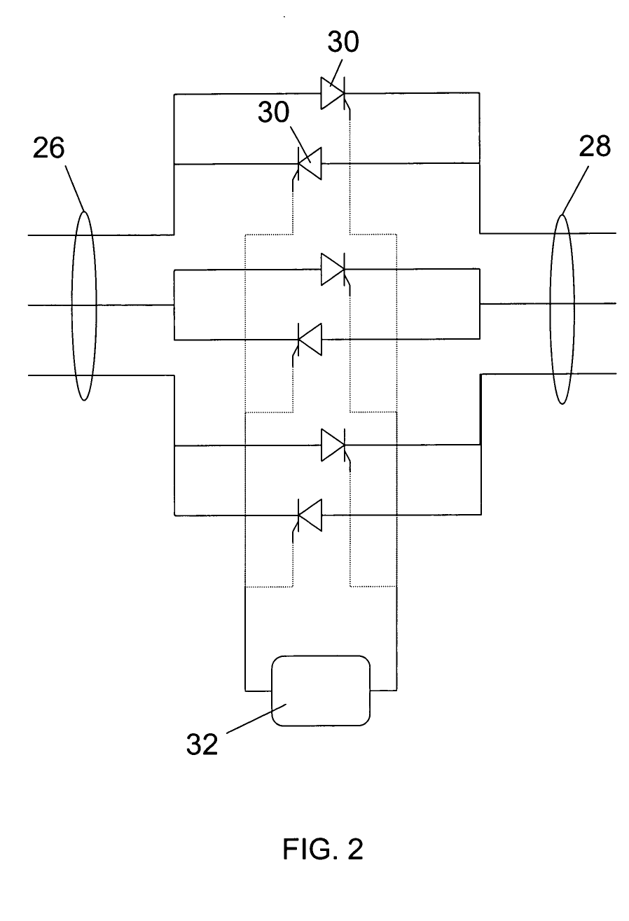

Referring also to FIG. 2, in the preferred embodiment, the switch 10 broadly comprises three pairs of silicon controlled rectifiers (SCR)s 30, one pair for each phase, and a controller 32 to control the SCRs 30. The SCRs 30 can be triggered or biased to selectively allow current to flow between the buses 12,14, thereby allowing the first source 16 to power both the first load 18 and the second load 22. Similarly, the SCRs 30 can be triggered to selectively allow the second source 20 to power both the first load 18 and the second load 22. The SCRs 30 are preferably of the hockey puck type and rated to carry all the power a largest one of the loads 18,22 consumes. For example, if the first load 18 consumes 800 amps on each phase and the second load 22 consumes 1000 amps on each phase, then each SCR 30 is preferably rated to handle at least 1000 amps continuously.

The controller 32 is preferably manually operated to trigger the SCRs 30. For example, if the first source 16 is to be shut-down, the controller 32 may simply substantially continuously trigger all of the SCRs 30, thereby effectively shorting the first bus 12 to the second bus 14. The circuit breaker 28 nearest the first source 16 may also be actuated to isolate the first source 16. In this case, the second source 20 provides power to both the second load 22 and the first load 18 through the buses 12,14 and the switch 10. It should be noted that shorting the buses 12,14 together in this manner would alternatively allow the second source 20 to be shut-down and the first source 16 would then provide power to the loads 18,22. It should be noted that the sources 16,20 are preferably substantially synchronized in order to avoid inducing power quality and other issues.

The controller 32 may be simple circuitry operated by a manual button or other simple shunt and configured to substantially simultaneously trigger all of the SCRs 30. However, the controller 32 may include more advanced circuitry, such as one or more microprocessors, capable of monitoring the buses 12,14. In this more advanced form, the controller 32 may confirm that, or wait until, the buses 12,14 are substantially synchronized before triggering the SCRs 30. The controller 32 may include a SCR indicator to indicate whether or not the SCRs 30 have been triggered and/or a synchronization indicator to indicate whether or not the buses 12,14 are substantially synchronized.

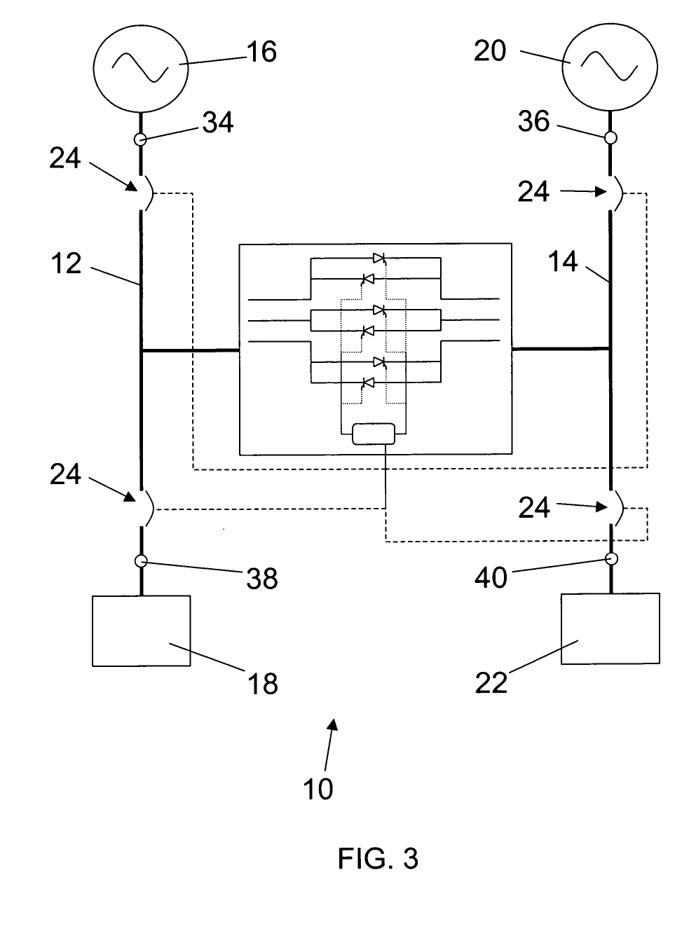

In a preferred second embodiment, as shown in FIG. 3, the switch 10 essentially includes the buses 12,14 and circuit breakers 24 as an integrated package, such that the sources 16,18 and loads 20,22 are connected directly to the switch 10. With all of these components integrated into the switch 10, the switch 10 may include first and second inputs 34,36 and first and second outputs 38,40. In this case, the controller 32 preferably has some control over the circuit breakers 24, such that the controller 32 may open any one or more of the circuit breakers 24 in order to isolate any one or more of the sources 16,20 and/or loads 18,22. Thus, the controller 32 can effectively instantly control power flow from the sources 16,20 and to the loads 18,22. The controller 32 may also include breaker indicators to indicate each circuit breaker's 24 status.

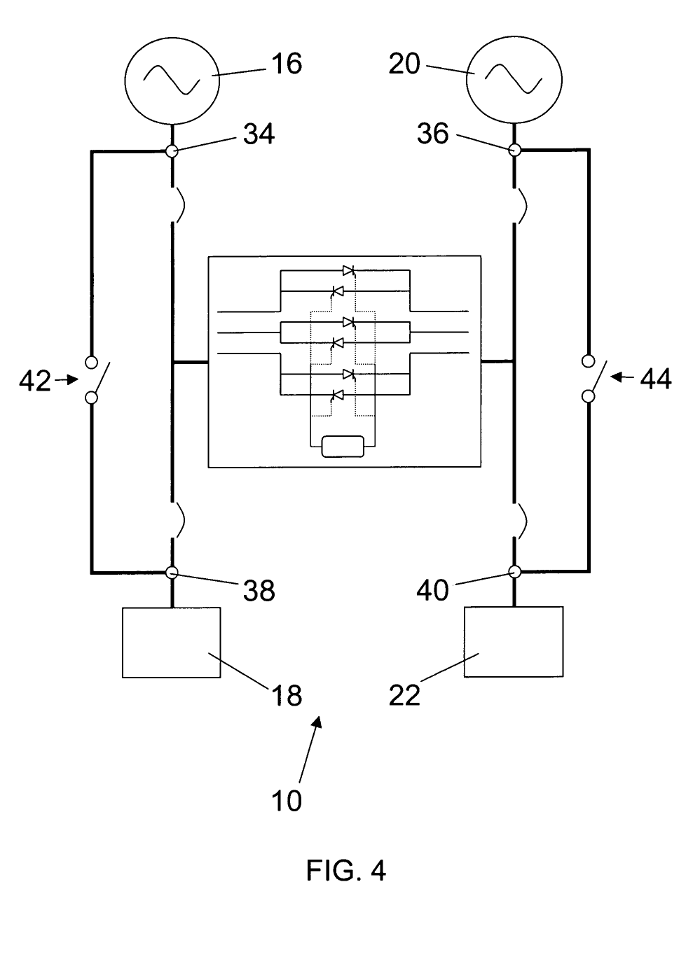

As shown in FIG. 4, the switch 10 may also include a first and second bypass 42,44 in order to provide for maintenance or replacement of any one or more of circuit breakers 28, the SCRs 30, the controller 32, or interconnecting wiring. The bypasses 42,44 are preferably manually operated and completely independent from the controller 32. The bypasses 42,44 may be tied together such that they operate substantially simultaneously. Alternatively, the bypasses 42,44 may also be completely independent of each other. In either case, the first bypass 42 is preferably operable to selectively connect the first input 34 directly to the first output 38. Similarly, the second bypass 44 is preferably operable to selectively connect the second input 36 directly to the second output 40.

While the present invention has been described above, it is understood that substitutions may be made. For example, the switch 10 may include additional circuit breakers, disconnects, or other isolators beyond what is disclosed herein, as a matter of design. However, it should be noted that a key object of the present invention is to provide a reliable static tie switch. Thus, care should be take in adding additional components, such that reliability is not sacrificed. The switch 10 could be adapted to handle more than the two buses 12,14. For instance, the switch 10 could interconnect three or more buses. In this case, the switch 10 would simply require more SCRs 30. Additionally, the SCRs 30 may be replaced with silicon controlled switches (SCS)s. It should be noted that SCSs are essentially a form of SCRs and are therefore considered equivalent thereto for the purposes of the present invention. Furthermore, the controller 32 may also control triggering of the SCRs 30 in order to synchronize the buses 12,14. These and other minor modifications are within the scope of the present invention.

While the switch 10 is preferably used for 208/480 Volt (V) power, the switch may be configured for other voltages. For example, the switch 10 may be used with lower voltages, such as 120 V and/or 220 V. The switch 10 may also be used with higher voltages, such as 2.3 Kilo Volts (KV), 4.16 KV, 12.47 KV, 13.8 KV, 25 KV, or 34.5 KV.

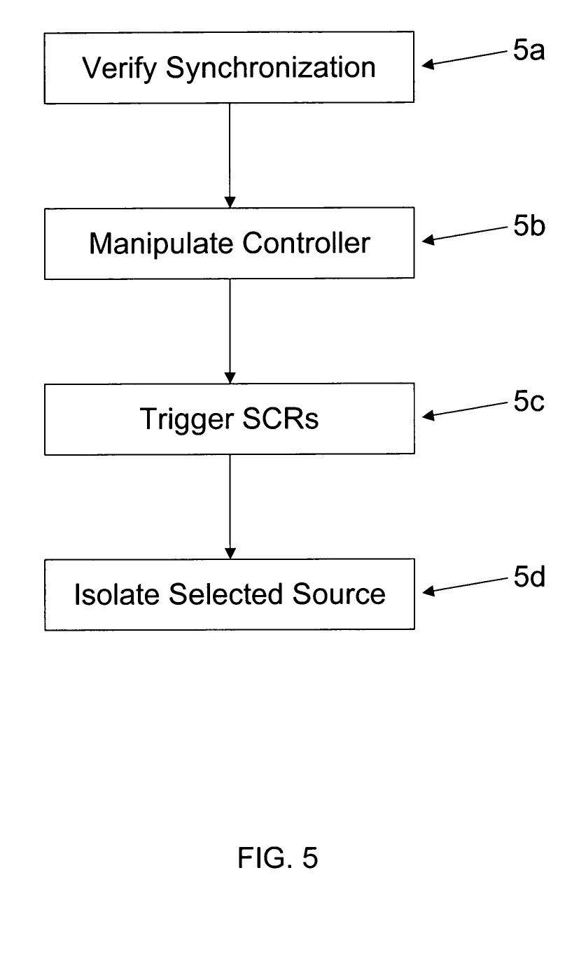

The flow chart of FIG. 5 shows the functionality and operation of a preferred implementation of the present invention in more detail. In this regard, some of the blocks of the flow chart may represent a module segment or portion of code of a program of the present invention which comprises one or more executable instructions for implementing the specified logical function or functions. In some alternative implementations, the functions noted in the various blocks may occur out of the order depicted. For example, two blocks shown in succession may in fact be executed substantially concurrently, or the blocks may sometimes be executed in the reverse order depending upon the functionality involved.

In use, as shown in FIG. 5, when a user wishes to shut down either one of the sources 16,20, the user first verifies that the buses 12,14 are synchronized, as shown in step 5a. Then, the user manipulates the controller 32 in order to tie the buses 12,14 together, as shown in step 5b. For example, the user may press the button or otherwise indicate that the controller 32 is to tie the buses 12,14 together. The controller 32 triggers all of the SCRs 30, thereby effectively shorting corresponding phases of the buses 12,14, as shown in step 5c.

At this point both sources 16,20 are providing power to the buses 12,14 and both loads 18,22 are drawing power from the buses 12,14. It is expected that shorting the buses 12,14 in this manner is not likely to cause significant disturbances in either of the sources 16,20 or loads 18,22 due to the characteristics of the SCRs 30.

Either the controller 32 or the user may then open the circuit breaker 28 closest to the source 16,20 that the user wishes to shut down, thereby isolating that source 16,20, as shown in step 5d. Alternatively, the controller 32 may open the appropriate circuit breaker 28 and trigger the SCRs 30 substantially simultaneously. Where the controller 32 is operable to open the circuit breakers 24, the user may indicate which source 16,20 he or she wishes to isolate, using the button or another input.

Finally, the user may perform the desired operation on the isolated source 16,20 without affecting either of the loads 18,22. When the user is finished and desires to bring the isolated source 16,22 back online, the user simply closes the appropriate circuit breaker 28 and separates the buses 12,14 using the controller 32.

It should be noted that even the simplest form of the switch 10 may still be used if the sources 16,20 are not synchronized. For example, the user may first open the appropriate circuit breaker 24, thereby de-energizing the appropriate bus 12,14 before the controller 32 shorts the buses 12,14 together.

1. A static tie switch operable to selectively allow power flow between a first bus and a second bus, the switch comprising:
a first feeder operable to be connected to the first bus;
a second feeder operable to be connected to the second bus; and
a solid-state interconnection between the feeders and operable to selectively tie the first bus to the second bus and selectively isolate the first bus from the second bus without the use of moving parts between the buses, thereby reliably allowing power to flow between the buses.

2. The switch as set forth in claim 1, wherein the interconnection includes a pair of silicon controlled rectifiers each operable to handle all of the power flow between the buses.

3. The switch as set forth in claim 1, wherein the feeders and the interconnection include three phases.

4. The switch as set forth in claim 3, wherein the interconnection includes three pairs of silicon controlled rectifiers (SCR)s each operable to handle all of the power flow between the buses for one of the phases.

5. The switch as set forth in claim 4, wherein each pair of SCRs electrically couples a different one of the phases of the first bus with a corresponding phase of the second bus.

6. The switch as set forth in claim 1, wherein the feeders and the interconnection are rated for a voltage selected from the group consisting of 120, 240, 208 and 480 Volts.

7. The switch as set forth in claim 1, wherein the feeders and the interconnection are rated for a voltage selected from the group consisting of 2.3, 4.16, 12.47, 13.8, 25, or 34.5 Kilo Volts.

8. The switch as set forth in claim 1, further including a controller to bias the interconnection, thereby shorting between the buses.

9. The switch as set forth in claim 8, wherein the controller is further operable to control a breaker in order to isolate a power source.

10. A static tie switch operable to be connected between a first source, a second source, a first load, and a second load, the switch comprising:
a first output operable to be connected to the first load;
a second output operable to be connected to the second load;
a first input operable to be connected to the first source, such that during normal operations the first input is connected to the first output with the first source suppling power to the first load;
a second input operable to be connected to the second source, such that during normal operations the second input is connected to the second output with the second source suppling power to the second load;
a solid-state interconnection between the inputs and outputs including three pairs of silicon controlled rectifiers (SCR)s operable to selectively tie the first output to the second input and selectively tie the second output to the first input;
a first circuit breaker operable to be connected between the first input and the interconnection;
a second circuit breaker operable to be connected between the second input and the interconnection;
a controller operable to control the interconnection and the breakers to isolate either one of the inputs, wherein the controller is able to manipulate the SCRs in order to tie both of the outputs to a selected one of the inputs;
a first bypass operable to selectively connect the first input directly to the first output, thereby bypassing the interconnection and the first circuit breaker; and
a second bypass operable to selectively connect the second input directly to the second output, thereby bypassing the interconnection and the second circuit breaker.

11. The switch as set forth in claim 10, wherein the feeders and the interconnection are rated for a voltage selected from the group consisting of 120, 240, 208 and 480 Volts.

12. The switch as set forth in claim 10, wherein the feeders and the interconnection are rated for a voltage selected from the group consisting of 2.3, 4.16, 12.47, 13.8, 25, or 34.5 Kilo Volts.

13. The switch as set forth in claim 10, wherein each pair of SCRs electrically couples a phase of the first bus with a phase of the second bus.
